(19) United States
(12) Patent Application Publication
(10) Pub. No.: US 2015/0253874 A1
(43) Pub. Date: Sep. 10, 2015

(54) TOUCH PAD PALM DETECTION

(71) Applicant: Andrew DE LOS REYES, Belmont, CA (US)

(72) Inventor: Andrew DE LOS REYES, Belmont, CA (US)

(73) Assignee: GOOGLE INC., Mountain View, CA (US)

(21) Appl. No.: 13/447,117

(22) Filed: Apr. 13, 2012

Related U.S. Application Data
(60) Provisional application No. 61/475,611, filed on Apr. 14, 2011.

(51) Int. Cl. G06F 3/041; G06F 3/0354; G06F 3/033

(52) U.S. Cl. CPC G06F 3/038; G06F 3/03547

(57) ABSTRACT

In certain aspects of the present disclosure, a system for preventing a palm from being incorrectly identified as a finger on a touch-sensitive input device and causing unintentional pointer movement or other unintended operation is provided. A dampened region may be defined on the surface of the touch-sensitive input device within which a user contact may not be reliably identified as a finger or a palm using a pressure threshold. In one aspect, a user contact that is within the dampened region and is below the pressure threshold may be prohibited from causing pointer movement unless the speed of the user contact exceeds a speed threshold. In one aspect, a user contact that is outside the dampened region may be identified as a finger or a palm based on comparing a pressure (e.g., contact area) of the user contact with the pressure threshold.

### CROSS-REFERENCE TO RELATED APPLICATION

This application claims the benefit of U.S. Provisional Patent Application No. 61/475,611, filed Apr. 14, 2011, entitled “TOUCH PAD PALM DETECTION,” the disclosure of which is hereby incorporated by reference in its entirety for all purposes.

### BACKGROUND

The present disclosure generally relates to detecting a palm on a touch-sensitive input device.

A user may input commands to a computing system (e.g., laptop) via a touch-sensitive input device (e.g., touch pad). For example, the user may move a finger across the surface of the input device to scroll a page or move a pointer displayed on the computing system. In this example, the input device may be used to track movements of the user's finger on the surface of the input device by frequently detecting the position (e.g., (x,y) coordinates) of the user's finger on the surface of the input device as the user's finger moves across the surface. The computing device may implement gesture recognition software that translates the detected positions of the user's finger into a gesture (e.g., pointer movement, scroll, etc.).

### SUMMARY

In certain aspects of the present disclosure, a system for preventing a palm from being incorrectly identified as a finger on a touch-sensitive input device and causing unintentional pointer movement or other unintended operations is provided. A dampened region may be defined on the surface of the touch-sensitive input device within which a user contact may not be reliably identified as a finger or a palm using a pressure threshold. In one aspect, user contact that is within the dampened region and is below the pressure threshold may be prohibited from causing pointer movement unless the speed of the user contact exceeds a speed threshold. In one aspect, user contact that is outside of the dampened region may be indentified as a finger or a palm based on comparing a pressure (e.g., contact area) of the user contact with the pressure threshold.

In another aspect of the present disclosure, a computer-implemented method of determining whether to move a pointer based on user contact with a touch-sensitive input device is provided. The method includes steps of determining that the user contact corresponds to the user's palm if the user contact was previously determined to correspond to the user's palm or if a pressure of the user contact is more than a predetermined pressure threshold, and prohibiting movement of the pointer based on the user contact if the user contact is determined to correspond to the user's palm.

In a further aspect of the present disclosure, a machine-readable storage medium is provided. The machine-readable storage medium stores at least machine-readable instructions for causing a processing unit to execute a method of determining whether to move a pointer based on user contact with a touch-sensitive input device. The method includes the steps of determining that the user contact corresponds to the user's finger if the user contact was previously determined to correspond to the user's finger or if a pressure of the user contact is less than a predetermined pressure threshold, and allowing movement of the pointer based on the user contact if the user contact is determined to correspond to the user's finger.

In an additional aspect of the present disclosure, a system for determining whether to move a pointer based on user contact with a touch-sensitive input device is provided. The system includes at least the touch-sensitive input device and a processing unit. The processing unit is configured to receive information from the touch-sensitive device about the user contact, to determine from the information that the user contact corresponds to the user's palm if the user contact was previously determined to correspond to the user's palm or if a pressure of the user contact is more than a predetermined pressure threshold, and to prohibit movement of the pointer based on the user contact if the user contact is determined to correspond to the user's palm.

Additional features and advantages of the invention will be set forth in the description below, and in part will be apparent from the description, or may be learned by practice of the invention. The advantages of the invention will be realized and attained by the structure particularly pointed out in the written description as well as in the appended drawings.

### BRIEF DESCRIPTION OF THE DRAWINGS

FIG. 1 is a conceptual diagram of an example system according to certain aspects of the disclosure.

FIG. 2 shows an example layout of a keyboard and a touch-sensitive input device according to certain aspects of the disclosure.

FIG. 3 shows an example surface of the touch-sensitive input device including a dampened region according to certain aspects of the disclosure.

FIG. 4 is a flowchart of an example method of determining whether a user contact corresponds to a finger or a palm according to certain aspects of the disclosure.

FIG. 5 is a block diagram illustrating an example computer system with which the system of FIG. 1 can be implemented.

### DETAILED DESCRIPTION

In the following detailed description, numerous specific details are set forth to provide a full understanding of the present disclosure. It will be apparent, however, to one ordinarily skilled in the art that aspects of the present disclosure may be practiced without some of these specific details. In other instances, well-known structures and techniques have not been shown in detail so as not to obscure the disclosure.

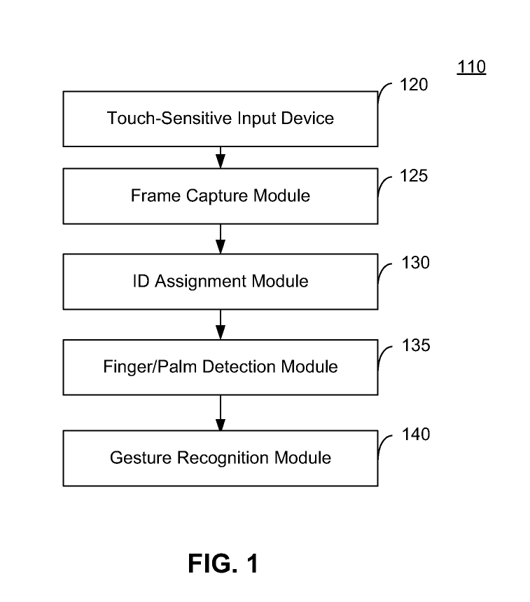

FIG. 1 shows an example system 110 according to certain aspects of the disclosure. The system 110 includes a touch-sensitive input device 120, a frame capture module 125, an identification (ID) module 130, a finger/palm detection module 135, and a gesture recognition module 140. The touch-sensitive input device 120 may include a touch pad.

In one aspect, the input device 120 may detect one or more user contacts on the surface of the input device 120, the position (e.g., (x,y) coordinates) of each user contact on the surface of the input device 120, and a pressure of each user contact, where the pressure may be defined as an area of contact with the surface of the input device 120. A user contact may correspond to contact of a finger or a palm of the user on the surface of the input device 120. In one aspect, the frame capture module 125 may sequentially capture and output frames where each frame includes the detected position (e.g., (x,y) coordinates) and pressure (e.g., contact area) of each user contact on the surface of the input device 120 at a given time instance. Each frame may include additional information, such as a sequential identifier to help maintain the correct sequence of frames. The frame capture module 125 may capture the frames at a rate of 80 frames per second, for example. However, the subject technology is not limited to this frame rate. The frame rate may vary depending on the manufacturer of the input device 120, the model of the input device 120, and/or other factors. The frame capture module 125 may output each captured frame to an ID module 130 for further processing, as discussed in more detail below.

In one aspect, the ID module 130 may be configured to assign an ID to each user contact detected on the surface of the input device 120. When a new user contact is detected in a frame, the ID module assigns a new ID to the user contact and identifies the user contact in subsequent frames by its assigned ID. For each frame, the ID module 130 may associate each detected position (e.g., (x,y) coordinates) in the frame with the ID assigned to the corresponding user contact.

In one aspect, the finger/palm detection module 135 may be configured to determine whether a user contact on the surface of the input device 120 corresponds to a finger or a palm of the user. Based on this determination, the finger/palm detection module 135 may generate a finger/palm identifier identifying the user contact as a finger or a palm.

The ID of a particular user contact allows the gesture recognition module 140 to identify which detected positions in different frames belong to the user contact, and therefore track the movements of the user contact on the surface of the input device 120. In addition, the corresponding finger/palm identifier allows the gesture recognition module 140 to determine whether the user contact corresponds to a finger or a palm. If the user contact corresponds to a finger, then the gesture recognition module 140 may translate movements of the user contact into a gesture (e.g., a pointer movement). If, on the other hand, the user contact corresponds to a palm, then the gesture recognition module 140 may disregard the user contact since a user normally does not enter commands using his/her palm. Thus, the ability to distinguish between a finger and a palm allows the gesture recognition module 140 to control a pointer based on movements of a finger on the surface of the input device 120 while disregarding a palm that may be resting on the surface of the input device 120 or unintentionally touching the surface of the input device 120.

In one aspect, the finger/palm detection module 135 may determine whether a user contact corresponds to a finger or a palm by comparing the pressure (e.g., contact area) of the user contact with a pressure threshold. If the pressure of the user contact is above the pressure threshold, then the finger/palm detection module 135 may determine that the user contact corresponds to a palm. For example, this is based on the assumption that a palm has a larger surface area than a finger, and therefore makes contact with the surface of the input device 120 over a larger area. If the pressure of the user contact is below the pressure threshold, then the finger/palm detection module 135 may determine that the user contact corresponds to a finger. The pressure threshold may be varied or optimized based on empirical data and/or the dimensions of the surface of the input device 120.

However, the finger/palm detection module 135 may not be able to reliably identify a palm when only a small portion of the palm makes contact with the surface of the input device 120. When only a small portion of the palm makes contact with the surface, the corresponding pressure may be too small for the finger/palm detection module 135 to distinguish from the pressure of a finger. An example of this situation is discussed below.

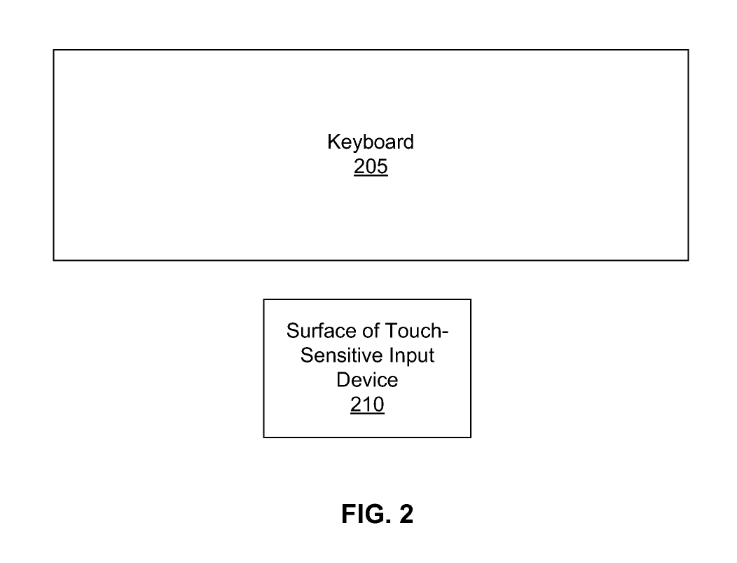

FIG. 2 shows an example of a layout of a keyboard 205 and the surface 210 of the touch-sensitive input device 120 (e.g., touch pad) for a computer (e.g., laptop computer). In this example, the surface 210 of the input device 120 is positioned directly below the keyboard 205. As a result, when the user types on the keyboard, one or both of the user's palms may unintentionally touch the surface 210 of the input device 120. In this example, a small portion of the palm may touch the surface 210 of the input device 120, resulting in a small pressure (e.g., below the pressure threshold) that can be indistinguishable from the pressure of a finger. If the finger/palm detection module 135 incorrectly identifies the palm as a finger due to the small pressure, then the gesture recognition module 140 may move a pointer in response to movements of the palm. This may cause unexpected pointer movements on the display of the computer since the user did not move a finger on the surface 210 of the input device 120. Thus, it is desirable that unintended touching of the surface 210 of the input device 120 by the user's palm does not result in pointer movements, clicks and/or other unintended operations.

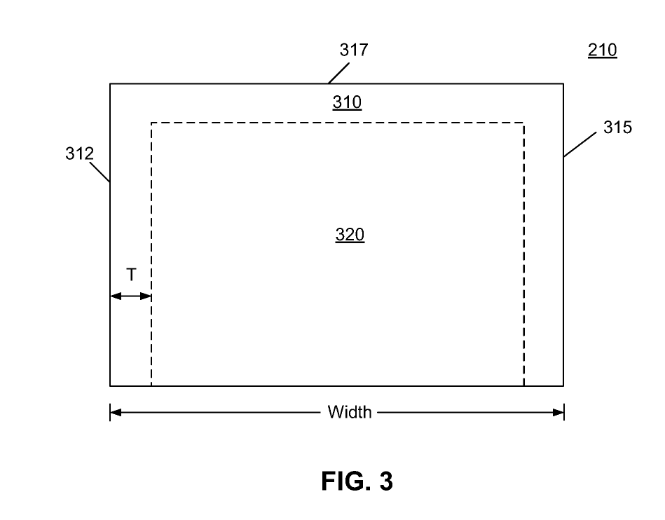

To address this issue, in one aspect of the subject technology, a dampened region may be defined on the surface 210 of the input device 120. FIG. 3 shows an example in which the dampened region 310 is defined along the two side edges 312 and 315 and the top edge 317 of the input device 120. FIG. 3 also shows a central region 320 that is offset from the two side edges 312 and 315 and the top edge 317 of the input device 120 by the dampened region 310.

The dampened region 310 may represent a region on the surface 210 of the input device 120 within which the finger/palm detection module 135 may not be able to reliably distinguish between a finger and a palm using the pressure threshold. The dampened region 310 may have a thickness T that is approximately equal to 5 to 15 percent the width W of the input device 120 (e.g., 8 percent of the width W). The thickness T of the dampened region 310 may be determined empirically. For example, the thickness T may be determined based on a minimum amount of the palm that needs to be placed on the surface of the input device 120 for the finger/palm detection module 135 to reliably distinguish between a finger and a palm using the pressure threshold. The dampened region 310 may be used to prevent a palm at an edge of the input device from causing unintentional pointer movement, as discussed further below.

In one aspect, if the pressure of a user contact exceeds the pressure threshold, then the finger/palm detection module 135 may determine that the user contact corresponds to a palm regardless of whether the user contact is located within the dampened region 310 or the central region 320.

In one aspect, if the user contact is located within the central region 320 and the pressure of the user contact is below the pressure threshold, then the finger/palm detection module 135 may determine that the user contact corresponds to a finger. In this case, the finger/palm detection module 135 may identify the user contact as a finger and the gesture recognition module 140 may respond to movements of the user contact accordingly (e.g., move a pointer in response to the movements of the user contact). This may be based on the assumption that, when a palm touches the surface 210 of the input device 120 within the central region 320, enough of the palm is in contact with the surface to reliability distinguish between a finger and a palm using the pressure threshold. If the user contact is identified as a finger within the central region 320 and subsequently moves into the dampened region 310, then the finger/palm detection module 135 may continue to identity the user contact as a finger.

Even after a user contact has been identified as a finger, the finger/palm detection module 135 may continue to compare the pressure of the user finger to the pressure threshold. If the pressure of the user finger rises above the pressure threshold, then the finger/palm detection module 135 may re-identify the user contact as a palm.

When a user contact within the dampened region 310 is below the pressure threshold, there may be some ambiguity whether the user contact corresponds to a finger or a palm. This is because, within the dampened region 310, a pressure below the pressure threshold may be due to a palm that is only partially touching the surface 210 of the input device instead of a finger. To prevent a palm within the dampened region 310 from unintentionally causing a pointer movement, the finger/palm detection module 135 may prohibit a user contact within the dampened region 310 that has not been designated a finger (e.g., originates in the dampened region 310) and is below the pressure threshold from causing pointer movement unless the speed of the user contact exceeds a speed threshold. For example, the finger/palm detection module 135 may prohibit the user contact from causing pointer movement by not identifying the user contact as a finger or not reporting the user contact to the gesture recognition module 140. If the speed of the user contact exceeds the speed threshold, then the finger/palm detection module 135 may assume that the user contact is a finger and identify the user contact as a finger to the gesture recognition module 140. This is because a palm may tend to move slowly, and therefore can be reliably distinguished from a finger based on speed. The speed threshold may be determined empirically, for example. If the user contact subsequently moves into the central region 320, then the finger/palm detection module 135 may identify the user contact as a finger or a palm using the pressure threshold. In this aspect, when the user places a finger within the dampened region 310, the user can move a pointer with the finger by moving the finger into the central region 320 or by moving the finger within the dampened region 310 above the speed threshold.

In one aspect, the speed of the user contact may be determined by computing a distance between the positions (e.g., (x,y) coordinates) of the user contact in two consecutive frames and dividing the distance by the time difference between two consecutive frames.

In an alternative aspect, the finger/palm detection module 135 may simply prohibit each user contact within the dampened region 310 that has not been designated a finger (e.g., originates in the dampened region 310) from causing pointer movement or prohibit all user contacts within the dampened region 310 from causing pointer movement. This aspect simplifies implementation of the finger/palm detection module 135 because the module 135 does not have to make a decision whether a user contact originating in the dampened region 310 is a finger or a palm. In this aspect, if the user places a finger within the dampened region 310, then the user may need to move the finger into the central region 320 to move a pointer with the finger.

The dampened region 310 is not limited to the example in FIG. 3, and may have other shapes. For example, the dampened region 310 may extend along just the top edge 317 of the input device, along just the side edges 312 and 315, or along just the top edge 317 and one of the side edges 312 and 315. In another example, the dampened region 310 may also extend along the bottom edge of the input device 120.

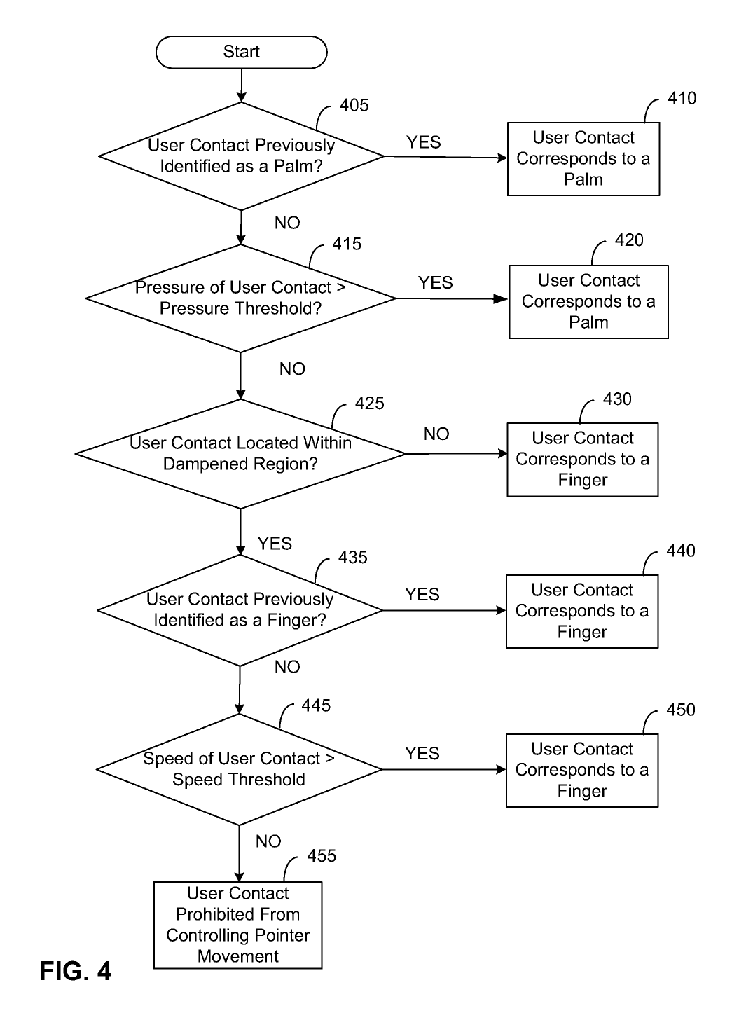

FIG. 4 shows an example method of determining whether a user contact corresponds to a finger or a palm according to aspects of the subject technology. The method may be implemented by the finger/palm detection module 135.

In step 405, a determination is made whether the user contact has been previously identified as a palm. If the user contact has been previously identified as a palm, then the user contact corresponds to a palm and is not used to control pointer movement in step 410. Otherwise, the method proceeds to step 415.

In step 415, a determination is made whether the pressure of the user contact is above the pressure threshold. If the pressure of the user contact is above the pressure threshold, then a determination is made that the user contact corresponds to a palm in step 420. Otherwise, the method proceeds to step 425.

In step 425, a determination is made whether the user contact is located within the dampened region 310. If the user contact is not within the dampened region 310 (e.g., outside the dampened region 310), then a determination is made that the user contact corresponds to a finger in step 430. This is because the user contact is outside the dampened region 310 and the pressure of the user contact does not exceed the pressure threshold. Otherwise, the user contact is within the dampened region 310, and the method proceeds to step 435.

In step 435, a determination is made whether the user contact has previously been identified as a finger. If the user contact has previously been identified as a finger, then the user contact corresponds to a finger in step 440 and may be used to control movement of the pointer. This may occur, for example, when the user contact has previously been identified as a finger outside the dampened region 310 and subsequently moves into the dampened region 310. Otherwise, the method proceeds to step 445.

In step 445, a determination is made whether the speed of the user contact exceeds the speed threshold. If the user contact exceeds the speed threshold, then the user contact corresponds to a finger and may be allowed to control movement of the pointer in step 450. In one aspect, once the speed of the user contact exceeds the speed threshold, the user contact may continue to be identified as a finger even if the speed of the user contact subsequently slows below the speed threshold. Otherwise, the user contact is prohibited from controlling pointer movement in step 455.

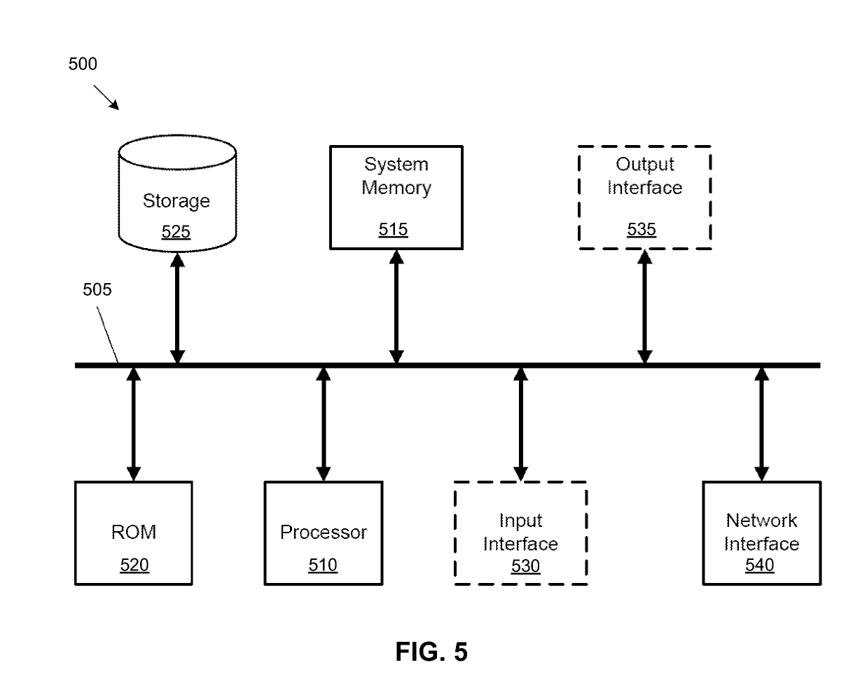

FIG. 5 illustrates an example computing system 500 with which some implementations of the subject technology may be implemented. The system 500 can be a computer, a phone, a PDA, a tablet, or any other sort of electronic device. Such a system 500 includes various types of computer readable media and interfaces for various other types of computer readable media. The system 500 may include a bus 505, processing unit(s) 510, a system memory 515, a read-only memory 520, a storage device 525, an input interface 530, an output interface 535, and a network interface 540.

The bus 505 collectively represents all system, peripheral, and chipset buses that communicatively connect the numerous internal devices of the system 500. For instance, the bus 505 communicatively connects the processing unit(s) 510 with the read-only memory 520, the system memory 515, and the storage device 525.

From these various memory units, the processing unit(s) 510 may retrieve instructions and execute the instructions to perform various functions described above. For example, the processing units(s) may execute instructions to perform the functions of the various modules illustrated in FIG. 1. The processing unit(s) can be a single processor or a multi-core processor in different implementations.

The read-only-memory (ROM) 520 may store static data and instructions that are needed by the processing unit(s) 510 and other modules of the system 500. The storage device 525, on the other hand, may be a read-and-write memory device. This device may comprise a non-volatile memory unit that stores instructions and data even when the system 500 is powered down. Some implementations of the invention may use a mass-storage device (such as a magnetic or optical disk and its corresponding disk drive) as the storage device 525.

Other implementations may use a removable storage device (such as a flash drive, a floppy disk, and its corresponding disk drive) as the storage device 525. The system memory 515 may be a volatile read-and-write memory, such as a random access memory. The system memory 515 may store some of the instructions and data that the processor needs at runtime. In some implementations, instructions for executing various processes described above may be stored in the system memory 515, the storage device 525, and/or the read-only memory 520.

The bus 505 may also connect to the input interface 530 and the output interface 535. The input interface 530 may include the touch-sensitive input device 120. The output interface 535 can provide display images generated by the system 500. The optional output interface 535 can interface with printers and display devices, such as cathode ray tubes (CRT) or liquid crystal displays (LCD). Some implementations can interface with devices such as a touchscreen that functions as both input and output devices.

The bus 505 may also couple the system 500 to a network interface 540 through a network adapter (not shown). In this manner, the computer can be a part of a network of computers (such as a local area network (“LAN”), a wide area network (“WAN”), or an Intranet, or an interconnected network of networks, such as the Internet. Any or all components of system 500 can be used in conjunction with the invention.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

These and other implementations are within the scope of the following claims.

1. A computer-implemented method of determining whether to move a pointer based on user contact with a touch-sensitive input device, comprising:
determining that the user contact corresponds to the user's palm if the user contact was previously determined to correspond to the user's palm;
prohibiting movement of the pointer based on the user contact if the user contact was previously determined to correspond to the user's palm;
determining that the user contact corresponds to the user's palm if a pressure of the user contact is more than a predetermined pressure threshold; and
prohibiting movement of the pointer based on the user contact if the user contact is determined to correspond to the user's palm based on determining the pressure of the user contact is more than the predetermined pressure threshold.

2. The computer-implemented method of claim 1, wherein the pressure of the user contact is measured based on a surface area of the user contact.

3. The computer-implemented method of claim 1, further comprising:
determining that the user contact corresponds to the user's palm if the user contact is located within a dampened region of the touch-sensitive input device; and
prohibiting movement of the pointer based on the user contact if the user contact is determined to correspond to the user's palm based on determining the user contact is located within the dampened region of the touch-sensitive input device.

4. The computer-implemented method of claim 3, wherein the dampened region comprises a top edge and side edges of the touch-sensitive input device.

5. The computer-implemented method of claim 4, wherein the dampened region further comprises a bottom edge of the touch-sensitive input device.

6. (canceled)

7. The computer-implemented method of claim 3, further comprising:
determining that the user contact corresponds to the user's palm if the user contact was not previously determined to correspond to the user's finger; and
prohibiting movement of the pointer based on the user contact if the user contact is determined to correspond to the user's palm based on determining the user contact was not previously determined to correspond to the user's finger.

8. The computer-implemented method of claim 3, further comprising:
determining that the user contact corresponds to the user's palm if a speed of the user contact is less than a predetermined speed threshold; and
prohibiting movement of the pointer based on the user contact if the user contact is determined to correspond to the user's palm based on determining the speed of the user contact is less than the predetermined speed threshold.

9. The computer-implemented method of claim 1, further comprising:
determining that the user contact corresponds to the user's finger if the user contact is not determined to correspond to the user's palm; and
allowing movement of the pointer based on the user contact if the user contact is determined to correspond to the user's finger.

10. A machine-readable storage medium comprising machine-readable instructions for causing a processing unit to execute a method of determining whether to move a pointer based on user contact with a touch-sensitive input device, the method comprising:
determining that the user contact corresponds to the user's finger if the user contact was previously determined to correspond to the user's finger;
allowing movement of the pointer based on the user contact if the user contact was previously determined to correspond to the user's finger;
determining that the user contact corresponds to the user's finger if a pressure of the user contact is less than a predetermined pressure threshold; and
allowing movement of the pointer based on the user contact if the user contact is determined to correspond to the user's finger based on determining the pressure of the user contact is less than the predetermined pressure threshold.

11. The machine-readable storage medium of claim 10, wherein the pressure of the user contact is measured based on a surface area of the user contact.

12. The machine-readable storage medium of claim 10, further comprising:
determining that the user contact corresponds to the user's finger if the user contact is located outside a dampened region of the touch-sensitive input device; and
allowing movement of the pointer based on the user contact if the user contact is determined to correspond to the user's finger based on determining the user contact is located outside the dampened region of the touch-sensitive input device.

13. The machine-readable storage medium of claim 12, wherein the dampened region comprises a top edge and side edges of the touch-sensitive input device.

14. The machine-readable storage medium of claim 13, wherein the dampened region further comprises a bottom edge of the touch-sensitive input device.

15. (canceled)

16. The machine-readable storage medium of claim 12, further comprising:
determining that the user contact corresponds to the user's finger if the user contact was not previously determined to correspond to the user's palm; and
allowing movement of the pointer based on the user contact if the user contact is determined to correspond to the user's finger based on determining the user was not previously determined to correspond to the user's palm.

17. The machine-readable storage medium of claim 12, further comprising:
determining that the user contact corresponds to the user's finger if a speed of the user contact is more than a predetermined speed threshold; and
allowing movement of the pointer based on the user contact if the user contact is determined to correspond to the user's finger based on determining the speed of the user contact is more than the predetermined speed threshold.

18. The machine-readable storage medium of claim 10, wherein the method further comprises:
determining that the user contact corresponds to the user's palm if the user contact is not determined to correspond to the user's finger; and
prohibiting movement of the pointer based on the user contact if the user contact is determined to correspond to the user's palm.

19. A system for determining whether to move a pointer based on user contact with a touch-sensitive input device, the system comprising:
the touch-sensitive input device; and
a processing unit configured to:
receive information from the touch-sensitive device about the user contact;
determine from the information that the user contact corresponds to the user's palm if the user contact was previously determined to correspond to the user's palm;
prohibit movement of the pointer based on the user contact if the user contact was previously determined to correspond to the user's palm;
determine that the user contact corresponds to the user's palm if a pressure of the user contact is more than a predetermined pressure threshold; and
prohibit movement of the pointer based on the user contact if the user contact is determined to correspond to the user's palm based on determining the pressure of the user contact is more than the predetermined pressure threshold.

20. The system of claim 19, wherein the pressure of the user contact is measured based on a surface area of the user contact.

21. The system of claim 19, wherein the processing unit is further configured to:
determine that the user contact corresponds to the user's palm if the user contact is located within a dampened region of the touch-sensitive input device; and
prohibit movement of the pointer based on the user contact if the user contact is determined to correspond to the user's palm based on determining the user contact is located within the dampened region of the touch-sensitive input.

22. The system of claim 21, wherein the dampened region comprises a top edge and side edges of the touch-sensitive input device.

23. The system of claim 22, wherein the dampened region further comprises a bottom edge of the touch-sensitive input device.

24. (canceled)

25. The system of claim 21, wherein the processing unit is further configured to:
determine that the user contact corresponds to the user's palm if the user contact was not previously determined to correspond to the user's finger; and
prohibit movement of the pointer based on the user contact if the user contact is determined to correspond to the user's palm based on determining the user contact was not previously determined to correspond to the user's finger.

26. The system of claim 21, wherein the processing unit is further configured to:
determine that the user contact corresponds to the user's palm if a speed of the user contact is less than a predetermined speed threshold; and
prohibit movement of the pointer based on the user contact if the user contact is determined to correspond to the user's palm based on determining the speed of the user contact is less than the predetermined speed threshold.

27. The system of claim 19, wherein the processing unit is further configured to:
determine that the user contact corresponds to the user's finger if the user contact is not determined to correspond to the user's palm; and
allow movement of the pointer based on the user contact if the user contact is determined to correspond to the user's finger.
